(19) United States
(12) Patent Application Publication
(10) Pub. No.: US 2024/0185023 A1
(43) Pub. Date: Jun. 6, 2024

(54) METHOD AND APPARATUS FOR VISUAL REASONING

(71) Applicants: Robert Bosch GmbH, Stuttgart (DE); TSINGHUA UNIVERSITY, Beijing (CN)

(72) Inventors: Bo Zhang, Beijing (CN); Chongxuan Li, Beijing (CN); Hang Su, Beijing (CN); Jun Zhu, Beijing (CN); Ke Su, Beijing (CN); Siliang Lu, Shanghai (CN); Ze Cheng, Shanghai (CN)

(21) Appl. No.: 18/546,842

(22) PCT Filed: Mar. 3, 2021
(86) PCT No.: PCT/CN2021/078877

§ 371 Date: Aug. 17, 2023

(51) Int. Cl. G06N 3/042; G06N 3/08

(52) U.S. Cl. CPC G06N 3/042; G06N 3/08

(57) ABSTRACT

A method for visual reasoning. The method includes: providing a network with sets of inputs and sets of outputs, wherein each set of inputs of the sets of inputs mapping to one of a set of outputs corresponding to the set of inputs based on visual information on the set of inputs, and wherein the network comprising a Probabilistic Generative Model (PGM) and a set of modules; determining a posterior distribution over combinations of one or more modules of the set of modules through the PGM, based on the provided sets of inputs and sets of outputs; and applying domain knowledge as one or more posterior regularization constraints on the determined posterior distribution.

### FIELD

Aspects of the present disclosure relate generally to artificial intelligence, and more particularly, to a method and a network for visual reasoning.

### BACKGROUND INFORMATION

Artificial Intelligence (AI) is widely deployed in a variety of areas such as image classification, object detection, scene understanding, machine translation and the like. There is an increasing interest in visual reasoning with an increasing growth of applications such as visual question answering (VQA), embodied question answering, visual navigation, autopilot and the like, where AI models may be generally required to perform high-level cognition processes over low-level perception results, for example, to perform high-level abstract reasoning upon simple visual concepts such as lines, shapes and the like.

Deep neural networks have been widely applied in visual reasoning, where deep neural networks may be trained to model the correlation between task input and output, and may gain success in various visual reasoning tasks with deep and rich representation learning, particular in perception tasks. Additionally, modularized networks have been drawn more and more attention for visual reasoning in recent years, which may unify deep learning and symbolic reasoning, focusing on building neural-symbolic models with the aim of combining the best of representation learning and symbolic reasoning. The main idea is to manually design neural modules that each represents a primitive step in the reasoning process, and solve reasoning problems by assembling those modules into respective symbolic networks corresponding to the solved reasoning problems.

With this modularized network with neural-symbolic methodology, a conventional visual question answering (VQA) problem may be generally solved properly, where questions are generally in form of texts. In addition to VQA, an abstract visual reasoning is recently proposed to extract abstract concepts or questions directly from a visual input without a natural language question, such as from an image, and conduct reasoning processes accordingly. As reasoning about abstract concepts has been a long-standing challenge in machine learning, the current visual reasoning methods or AI models as described above may have an unsatisfying performance on such an abstract visual reasoning task.

It may be desirable to provide even improved methods or AI models to process abstract visual reasoning tasks.

### SUMMARY

The following presents a simplified summary of one or more aspects according to the present invention in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the present invention, a method for visual reasoning is provided. According to an example embodiment of the present invention, the method comprises: providing a network with sets of inputs and sets of outputs, wherein each set of inputs of the sets of inputs mapping to one of a set of outputs corresponding to the set of inputs based on visual information on the set of inputs, and wherein the network comprising a Probabilistic Generative Model (PGM) and a set of modules; determining a posterior distribution over combinations of one or more modules of the set of modules through the PGM, based on the provided sets of inputs and sets of outputs; and applying domain knowledge as one or more posterior regularization constraints on the determined posterior distribution.

In another aspect of the present invention, a method for visual reasoning with a network comprising a Probabilistic Generative Model (PGM) and a set of modules is provided. According to an example embodiment of the present invention, the method comprises: providing the network with a set of input images and a set of candidate images; generating a combination of one or more modules of the set of modules based on a posterior distribution over combinations of one or more modules of the set of modules and the set of input images, wherein the posterior distribution is formulated by the PGM trained under domain knowledge as one or more posterior regularization constraints; processing the set of input images and the set of candidate images through the generated combination of one or more modules; and selecting a candidate image from the set of candidate images based on a score of each candidate image in the set of candidate images estimated by the processing.

In another aspect of the present invention, a network for visual reasoning is provided. According to an example embodiment of the present invention, the network comprises: a set of modules, wherein each of the set of modules being implemented as a neural network and having at least one trainable parameters for focusing that module on one or more variable image properties; and a Probabilistic Generative Model (PGM) coupled to the set of modules, wherein the PGM is configured to output a posterior distribution over combinations of one or more modules of the set of modules.

In another aspect of the present invention, an apparatus for visual reasoning comprises a memory; and at least one processor coupled to the memory. According to an example embodiment of the present invention, the at least one processor is configured to provide a network with sets of inputs and sets of outputs, wherein each set of inputs of the sets of inputs mapping to one of a set of outputs corresponding to the set of inputs based on visual information on the set of inputs, and wherein the network comprising a Probabilistic Generative Model (PGM) and a set of modules; determine a posterior distribution over combinations of one or more modules of the set of modules through the PGM, based on the provided sets of inputs and sets of outputs; and apply domain knowledge as one or more posterior regularization constraints on the determined posterior distribution.

In another aspect of the present invention, a computer program product for visual reasoning is provided. According to an example embodiment of the present invention, the computer program product comprises processor executable computer code for providing a network with sets of inputs and sets of outputs, wherein each set of inputs of the sets of inputs mapping to one of a set of outputs corresponding to the set of inputs based on visual information on the set of inputs, and wherein the network comprising a Probabilistic Generative Model (PGM) and a set of modules; determining a posterior distribution over combinations of one or more modules of the set of modules through the PGM, based on the provided sets of inputs and sets of outputs; and applying domain knowledge as one or more posterior regularization constraints on the determined posterior distribution.

In another aspect of the present invention, a computer readable medium stores computer code for visual reasoning. According to an example embodiment of the present invention, the computer code when executed by a processor causes the processor to provide a network with sets of inputs and sets of outputs, wherein each set of inputs of the sets of inputs mapping to one of a set of outputs corresponding to the set of inputs based on visual information on the set of inputs, and wherein the network comprising a Probabilistic Generative Model (PGM) and a set of modules; determine a posterior distribution over combinations of one or more modules of the set of modules through the PGM, based on the provided sets of inputs and sets of outputs; and apply domain knowledge as one or more posterior regularization constraints on the determined posterior distribution.

With the guidance of the domain knowledge, the generated modularized networks may provide structures that may represent human-interpretable reasoning process precisely, which may lead to improved performance.

Other aspects or variations of the present invention, as well as other advantages thereof will become apparent by consideration of the following detailed description and the figures.

### BRIEF DESCRIPTION OF THE DRAWINGS

The disclosed aspects of the present invention will hereinafter be described in connection with the figures that are provided to illustrate and not to limit the disclosed aspects.

FIG. 1 shows an example of abstract visual reasoning, according to the present invention.

FIG. 2 illustrates an example network in which aspects of the present invention may be performed.

FIG. 3A and FIG. 3B illustrate example modularized networks with different structures, according to the present invention.

FIG. 4 shows an exemplary flow chart illustrating a method for performing an abstract visual reasoning task with a probabilistic neural-symbolic model that is regularized with domain knowledge, according to one or more aspects of the present invention.

FIG. 5 illustrates an exemplary flow chart illustrating an optimization process for abstract visual reasoning task, according to one or more aspects of the present invention.

FIG. 6 shows an exemplary flow chart illustrating a method for performing an abstract visual reasoning task with a probabilistic neural-symbolic model that is regularized with domain knowledge, according to one or more aspects of the present invention.

FIG. 7 illustrates another example network in which aspects of the present invention may be performed.

FIG. 8 shows an exemplary diagram illustrating an example of performing method, and optimization process for abstract visual reasoning task by another example network, according to one or more aspects of the present invention.

FIG. 9 illustrates an example of a hardware implementation for an apparatus according to an embodiment of the present invention.

### DETAILED DESCRIPTION OF EXAMPLE EMBODIMENTS

The present invention will now be discussed with reference to several example implementations. It is to be understood that these implementations are discussed only for enabling those skilled in the art to better understand and thus implement the embodiments of the present invention, rather than suggesting any limitations on the scope of the present invention.

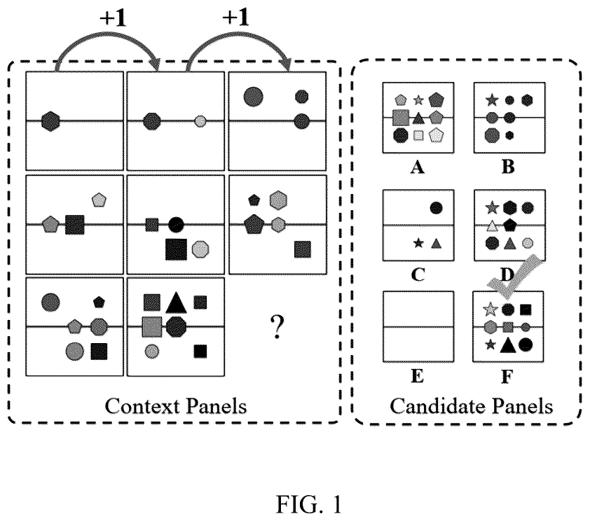

Moving one step ahead of traditional computer vision tasks such as image classification and object detection, visual reasoning requires not only a comprehensive understanding of the visual content, but also the capability of reasoning about the extracted concepts to draw a conclusion. FIG. 1 shows an example of abstract visual reasoning, where the eight image panels in the left dotted box are a set of inputs, and the six image panels in the right dotted box are a set of outputs. There may exist one or more common rules among the set of inputs and the correct one of the set of outputs. In order to select the correct output panel from several candidate output panels to fill in the blank of the left dotted box, the common rules shall be extracted and used to map to the correct output panel. For instance, in the example of FIG. 1, the common rule among the eight input image panels may be ascending numbers of shapes by row, and the correct output panel D may be selected based on the rule. For instance, extracting the rule of ascending numbers of shapes by row may be a high-level abstract reasoning task that may be based on one or more low-level visual concepts such as various shapes in each of the input image panels.

The present disclosure proposes a method for performing an abstract visual reasoning task with a probabilistic neural-symbolic model that is regularized with domain knowledge. A neural-symbolic model may provide a powerful tool in combining symbolic program execution for reasoning and deep representation learning for visual recognition. For instance, a neural-symbolic model may compose a particular modularized network that may comprise one or more modules selected from a set of modules, such as an inventory of reusable modules, for each set of inputs. A probabilistic formulation to train models with stochastic latent variables may obtain an interpretable and legible reasoning system with fewer supervisions. Domain knowledge may provide guidance in a generation of a reasonable modularized network, as it may generally involve an optimization problem with a mixture of continuous and discrete variables in the generation. With the guidance of the domain knowledge, the generated modularized networks may provide structures that may represent human-interpretable reasoning process precisely, which may lead to improved performance.

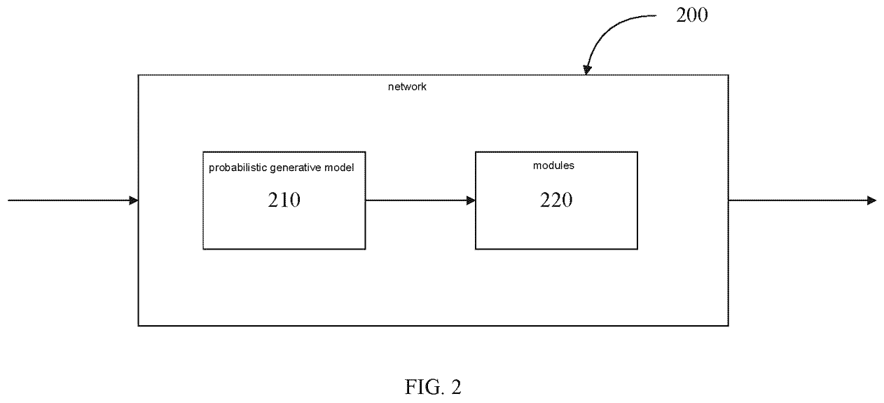

FIG. 2 illustrates an example network 200 in which aspects of the present disclosure may be performed. For instance, the network 200 may include a probabilistic generative model (PGM) 210 and a set of modules 220, such as an inventory of reusable modules. In an aspect of the present disclosure, a plurality of combinations of one or more modules may be selected from the set of modules 220 for solving respective sets of inputs, and the plurality of combinations of the set of modules 220 may be considered as a latent variable for which a posterior distribution may be formulated through the PGM 210 by learning a dataset. For instance, one or more modules may be selected from the inventory of reusable modules to assemble a modularized network with a structure indicating the assembled modules and the connections there between. For instance, the structure of the assembled modularized network may be represented as a directed acyclic graph (DAG). The PGM 210 may be used to formulate a distribution over structures of modularized networks, where the set of modules 220 may be an inventory of reusable modules for assembling modularized networks. For instance, the PGM 210 may formulate a posterior distribution over structures of modularized networks via learning a dataset. The formulated posterior distribution over structures of modularized networks may be regularized with domain knowledge.

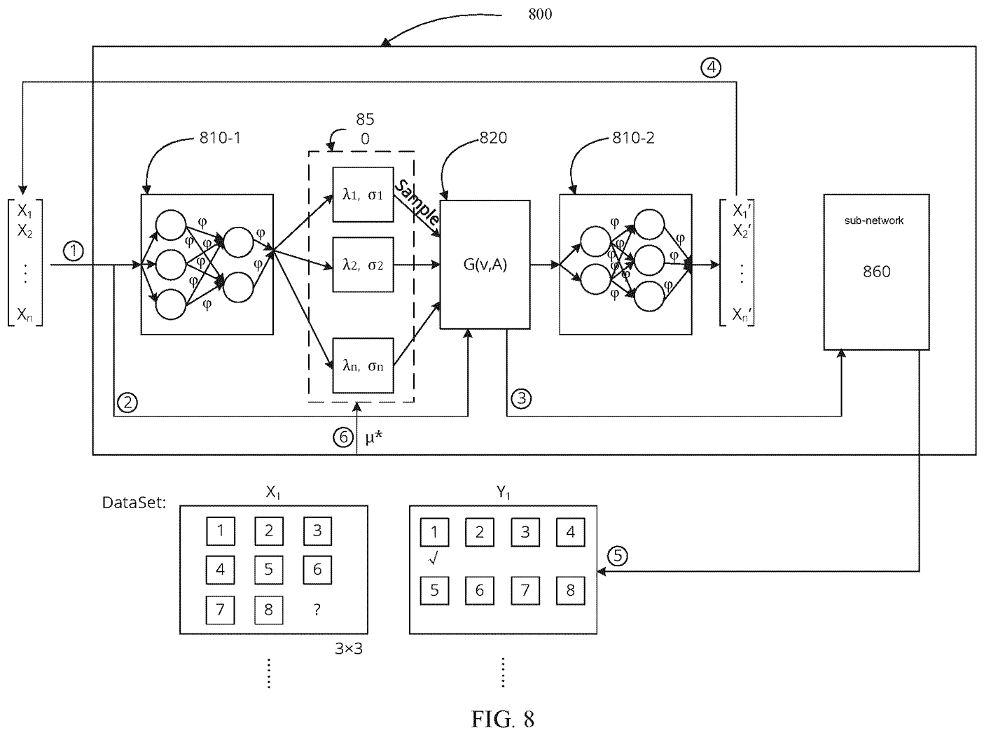

For instance, the PGM 210 may comprise a variational auto-encoder (VAE), where an encoder of a VAE may formulate a variational posterior distribution of structures of modularized networks, and a decoder of the VAE may formulate a generative distribution. The formulated variational posterior distribution of structures of modularized networks by the encoder may be an estimated posterior distribution of structures of modularized networks based on the observed dataset. The formulated generative distribution by the decoder may be used for reconstruction (as illustrated via route 4 of FIG. 8). In some aspects of the present disclosure, a decoder may be omitted in the PGM 210. In other aspects of the present disclosure, an encoder and a decoder may both exist in the PGM 210.

For instance, the set of modules 220 may comprising one or more pre-designed neural modules, with each representing a primitive step in a reasoning process. For instance, each module of the set of modules 220 may be implemented as a multi-layer neural network with one or more trainable parameters. In an aspect of the present disclosure, each module of the set of modules 220 may be dynamically assembled with each other to form a particular modularized network, which may be used to map a given set of inputs to the correct output. In an aspect of the present disclosure, the PGM 210 may be used to generate modularized networks with structures corresponding to individual sets of inputs, to predict the respective underlying rules within individual sets of inputs.

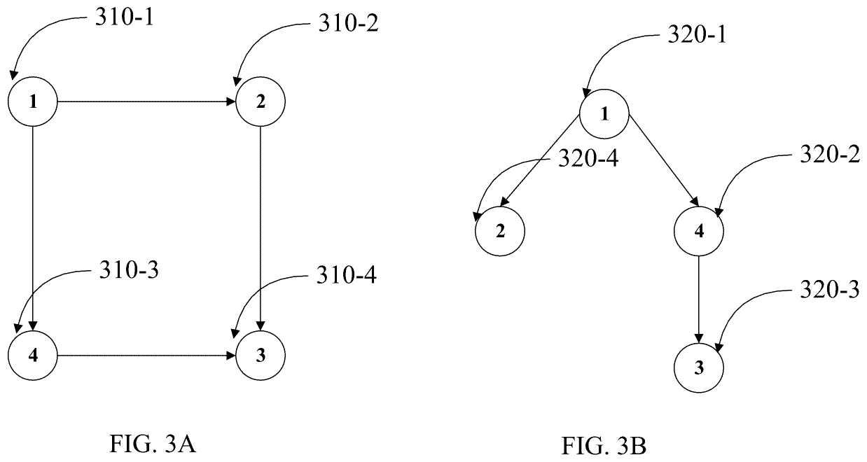

FIG. 3A and FIG. 3B illustrate example modularized networks with different structures. For instance, the structure of the modularized network may be represented as a DAG, which may be denoted by G=(v,A), where v ∈ M^{d}, v may represent each node (i.e., each module) of the structure, M may represent the set of modules 220, d is the size of the structure, and A ∈ {0,1}^{d×d} is the adjacency matrix that may represent the connections between the modules of the structure. For instance, the number of the vertexes of the graph may be specified to be less or equal to a threshold number (e.g., d≤4, or 6 or the like), and each vertex may be filled with a particular module from the set of modules 220. For instance, the set of modules M 220 may include ten modules numbered from 0 to 9, which may be represented as v₀, v₁, v₂, v₃, x₄, v₅, v₆, v₇, v₈, v₉.

As an example, the structure shown in FIG. 3A may have modules v₁, v₂, v₃, v₄ filled into vertexes 310-1, 310-2, 310-4 and 310-3 respectively, and an adjacency matrix

$$A = \{ \begin{matrix}0 & 1 & 1 & 0 \\ 0 & 0 & 0 & 1 \\ 0 & 0 & 0 & 1 \\ 0 & 0 & 0 & 0\end{matrix} \} .$$

As another example, the structure shown in FIG. 3B may have modules v₁, v₂, v₃, v₄ filled into vertexes 310-1, 310-4, 310-3 and 310-2 respectively, and an adjacency matrix

$$A = \{ \begin{matrix}0 & 1 & 0 & 1 \\ 0 & 0 & 1 & 0 \\ 0 & 0 & 0 & 0 \\ 0 & 0 & 0 & 0\end{matrix} \} .$$

In some aspects of the present disclosure, the modularized networks with respective structures shown in FIG. 3A and FIG. 3B may be appropriate for extracting different rules contained within different sets of inputs. In an aspect of the present disclosure, through training a dataset comprising sets of inputs and sets of outputs corresponding to respective sets of inputs, the network 200 or 700 may learn associations between the sets of inputs and corresponding structures that may be used to map to the respective correct outputs. For instance, a posterior distribution of structures of modularized networks may be learned by the PGM 210 and may be used for inferring a structure of a modularized network for an arbitrary set of inputs. In another aspect of the present disclosure, domain knowledge may be applied in generation of structures. For instance, domain knowledge may be applied on the posterior distribution of structures of modularized networks learned by the PGM 210 through the dataset as one or more posterior regularization constraints. With the guidance of the domain knowledge, the regularized distribution of structures of modularized networks may be used to generate a precise and interpretable structure for a set of inputs that may represent hidden rules among the set of inputs.

It will be appreciated by those skilled that other structures may be possible, and other representations for at least part of the set of modules 220 may be also possible.

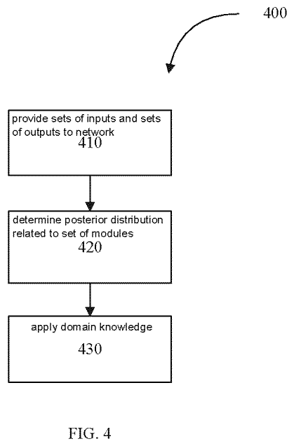

FIG. 4 shows an exemplary flow chart illustrating a method 400 for performing an abstract visual reasoning task with a probabilistic neural-symbolic model that is regularized with domain knowledge, according to one or more aspects of the present disclosure. For instance, the method 400 may be performed by the network 200 and network 700 that will be described in details hereafter. For another instance, the method 400 may be performed by other networks, systems or models.

In block 410, sets of inputs and sets of outputs may be provided to a network 200 or 700, wherein each set of inputs of the sets of inputs may map to one of a set of outputs corresponding to the set of inputs based on visual information on the set of inputs. For instance, the sets of inputs and sets of outputs may comprise a training dataset, such as Procedurally Generated Matrice (PGM) dataset, or Relational and Analogical Visual rEasoNing dataset (RAVEN) or the like. The network 200, 700 may comprise a Probabilistic Generative Model (PGM) 210, 710 and a set of modules 220, 720.

In block 420, a posterior distribution related to the set of modules 220, 720 may be determined through the PGM 210, 710 based on the provided sets of inputs and sets of outputs. In an aspect of the present disclosure, a posterior distribution over combinations of one or more modules of the set of modules 220, 720 may be determined through the PGM 210, 710, based on the provided sets of inputs and sets of outputs. In an example, the combinations of one or more modules of the set of modules 220, 720 may comprise modularized networks assembled from one or more modules of the set of modules 220, 720, wherein the modularized networks may have structures that may be represented as G=(v,A). In another example, the combinations of one or more modules of the set of modules 220 may comprise any permutations of one or more modules among the set of modules 220. For instance, the PGM 210 may comprise a VAE. An estimated posterior distribution over structures of modularized networks may be formulated through an encoder of the VAE based on the observed dataset.

In block 430, domain knowledge may be applied to the determined posterior distribution of the set of modules 220 as one or more posterior regularization constraints. For instance, a regularized Bayesian framework (RegBayes) may be used to incorporate human domain knowledge into Bayesian methods by directly apply constraints on the posterior distribution. The flexibility of RegBayes may allow explicitly considering domain knowledge by incorporating knowledge into any Bayesian models as soft constraints.

With the guidance of the domain knowledge, the method 400 may be utilized to generate precise and interpretable structures for different sets of inputs, as the generated structures may capture hidden rules among the sets of inputs.

It will be appreciated by those skilled that other probabilistic generative models may be possible, and other distributions related to the set of modules 220 may be also possible.

In one aspect of the present disclosure, one or more posterior regularization constraints may comprise one or more First-Order Logic (FOL) constraints that may carry domain knowledge. For instance, a constraint function may consist of first-order logic computations over each of structures and each of sets of inputs. Specifically, each constraint function takes each of structures and each of sets of inputs as input, and compute the designed first-order logic expression as output. The output of the constraint function may take a value in a range of [0, 1] that may indicate the degree that the input of each of structures and each of sets of inputs satisfies a specific demand, where lower value may show stronger correspondence. Therefore, by minimizing values of such constraint functions during the optimization of the posterior distribution of structures, the network 200 may learn to generate structures that may be in correspondence with the applied domain knowledge.

In another aspect of the present disclosure, it may be beneficial to consider inner correlations among constraints. Constraints concerning different aspects of domain knowledge may be independent with each other. On the other hand, constraints applied to different nodes of a structure but sharing a same aspect of domain knowledge may be correlated with each other. Accordingly, the constraints sharing the same aspect of domain knowledge may be grouped into a group of constraints. For instance, a total L groups of constraints may be proposed, where each group may correspond to a certain reasoning type, including Boolean logical reasoning, temporal reasoning, spatial reasoning, arithmetical reasoning, and the like.

In another aspect of the present disclosure, the one or more FOL constraints may be generated based on one or more properties of each of sets of inputs. For instance, in a Procedurally Generated Matrices (PGM) dataset, each pair of a set of inputs and the corresponding set of outputs may have one or more rules, each rule may be represented as a triple, [symbol] ={[r,o,a]:r ∈ [symbol] , o ∈ [symbol] , a ∈ [symbol] }, which is sampled from the following primitive sets:
Relation types: ( [symbol] , with elements r): progression, XOR, OR, AND, consistent union
Object types: ( [symbol] , with elements o): shape, line
Attribute types: ( [symbol] , with elements a): size, type, colour, position, number

These triples may determine abstract reasoning rules exhibited by a particular set of inputs and the corresponding correct output. For instance, if [symbol] contains the triple [progression, shape, colour], the set of inputs and corresponding correct output may exhibit a progression relation, instantiated on the colour (e.g., greyscale intensity) of shapes. For instance, each attribute type a ∈ [symbol] (e.g., colour) may take one of a finite number of discrete values z ∈ Z (e.g., 10 integers between [0, 255] denoting greyscale intensity). Therefore, a given rule [symbol] may have a plurality of realizations depending on the values for the attribute types, but all of these realizations may share the same underlying abstract rule. The choice of r may constrain the values of z that may be realized. For instance, if r is progression, the values of z may increase along rows or columns in the matrix of input image panels, and may vary with different values under this rule.

In an aspect of the present disclosure, the one or more FOL constraints may be generated based on at least one of relation types, object types or attribute types of the sets of inputs. For instance, an example formation of FOL constraint may be given by:

Φⱼ(G, x):=1−1[vⱼ ∈ S(x)] (1)

Where 1[·] is the indicator function and vⱼ ∈ S(x) is true if the semantic representation of vⱼ can be found in S(x). Where S(x) is semantic attributes of a set of inputs x that may be extracted from one or more triples [symbol] {[r,o,a]} of the set of inputs x. Where the j-th node in the structure G is denoted by vⱼ.

In one or more aspects of the present disclosure, a group of FOL constraints may be generated based on one or more triples [symbol] {[r,o,a]} of the set of inputs x, according to a certain aspect of domain knowledge, such as logical reasoning, temporal reasoning, spatial reasoning, or arithmetical reasoning and the like. For instance, logical reasoning may comprise logical AND, OR, XOR and the like. For instance, arithmetical reasoning may comprise arithmetical ADD, SUB, MUL and the like. For instance, spatial reasoning may comprise STRUC (Structure), e.g., for changing the computation rules of input modules, and the like. For instance, temporal reasoning may comprise PROG (Progress), ID (Identical) and the like.

In one or more aspects of the present disclosure, a group of FOL constraints that are generated according to a certain aspect of domain knowledge may be applied to each of nodes of a structure, respectively. For instance, constraints in the group may perform one FOL rule on all nodes of the structure which may check the certain aspect of domain knowledge.

It will be appreciated by those skilled that the one or more of the aspects described above may be performed by the network 200, 700 or other networks, systems, or models.

In one example, in the exemplary flow chart of method 400, reasoning tasks may be performed by optimizing trainable parameters of PGM 210, 710 and modules of the set of modules 220, 720, which is to minimize the prediction loss over observed samples, as formulated by following objective:

min_{φ}min_{θ} [symbol] ₑᵣᵣ(φ,θ):=Σ_{D}Σ_{G˜q}_{_{φ}}[−log pₙₑₜ(yₙ|xₙ,G,θ)] (2)

Where φ denotes trainable parameters in the PGM 210, 710, θ denotes trainable parameters of modules of the set of modules 220, 720, and D={(xₙ,yₙ)}_{n=1:N} denotes a dataset comprising n-th input xₙ associated with output yₙ.

In an aspect of the present disclosure, the network 200, 700 may utilize a PGM 210, 710 to formulate a generative distribution p_{φ}(x|G) and a variational distribution q_{φ}(G|x). For instance, an encoder of a VAE may formulate the variational distribution q_{φ}(G|x), and a decoder of the VAE may formulate the generative distribution p_{φ}(x|G). In particular, by optimizing the formulation (2), an estimated posterior distribution of structures \tilde{p}_{φ}_{₀}(G|x) and corresponding module parameters θ₀ may be obtained.

In another aspect of the present disclosure, one or more FOL constraints may be applied for regularization to generate the new posterior distribution of structures q_{φ}(G|x). Formally, the overall objective may be written as:

$${min}_{φ , ξ , η} {min}_{θ} {l}_{err} ( φ , θ ) + {C}_{1} {\sum }_{i = 1}^{L} {ξ}_{i} + {C}_{2} η , \qquad ( 3 )$$

$$s . t . ∀ i , {E}_{{x}_{n} ∈ D} \vert {E}_{G \sim {q}_{φ}} [ {\sum }_{j = 1}^{{T}_{i}} {Φ}_{i j} ( G , {x}_{n} ) ] \vert \leq {ξ}_{i} + ϵ ,$$

$$KL [ {q}_{φ} ( G \vert x ) ‖ {\tilde{p}}_{{φ}_{0}} ( G \vert x ) ] \leq η + ϵ ,$$

$$Where {φ}_{0} = arg {min}_{φ} {ℓ}_{err} ( φ ; θ )$$

Where q_{φ}(G|x) is the regularized posterior distribution of structures, \tilde{p}_{φ}_{₀}(G|x) is the estimated posterior distribution of structures given by optimizing the formulation (2), ξ_{i=1:L}≥0 and n≥0 are slack variables with corresponding regularization parameters C₁ and C₂, and ϵ is a small positive precision parameter.

The Φᵢⱼ(G, xₙ) functions in formulation (3) whose values may be bounded by the slack variables are FOL constraints. In one example, each constrain function may take a value in a range of [0,1] where smaller value may denote better correspondence of the structure G and input xₙ according to domain knowledge. It should be noted that constraint functions may form L groups instead of being independent from each other. The i-th group may comprise Tᵢ correlating constraints, which may correspond to a shared slack variables ξᵢ.

While the main goal of formulation (3) may be to minimize the task loss [symbol] ₑᵣᵣ, the slack variables ξ_{i=1:L} in the formulation may take the FOL constraints into consideration. The process of structure generation may be regularized with the applied domain knowledge. In order to reach the minimum of the whole objective, the network 200, 700 may learn to generate structures that satisfy the applied FOL constraints properly. Moreover, the KL-divergence between q_{φ}(G|x)and \tilde{p}_{φ}_{₀}(G|x) may be considered as an additional constraint, which may prevent the network 200 or 700 from over-reacting to domain knowledge.

It will be appreciated that one or more additional constraints may be added, and one or more exemplary constraints described above may be omitted.

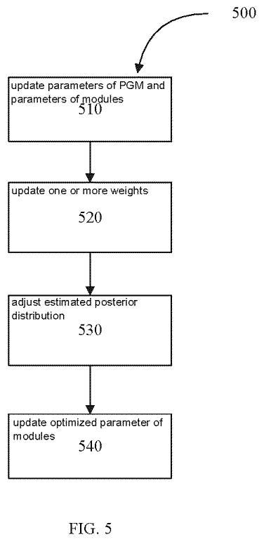

FIG. 5 illustrates an exemplary flow chart illustrating an optimization process 500 for the formulation (3), according to one or more aspects of the present disclosure. For instance, the process 500 may be performed by the network 200, network 700 that will be described in details hereafter, or other networks, systems, models or the like.

In block 510, parameters of the PGM 210, 710 and parameters of modules of the set of modules 220, 720 may be updated alternatively by maximizing evidences of the sets of inputs and the sets of outputs, to obtain an estimated posterior distribution over the combinations of one or more modules of the set of modules 220, 720 and optimized parameters of the modules of the set of modules 220, 720.

In block 520, one or more weights of one or more posterior regularization constraints applied to the estimated posterior distribution over the combinations of one or more modules of the set of modules 220, 720 may be updated, to obtain one or more optimal solutions of the one or more weights.

In block 530, the estimated posterior distribution over the combinations of one or more modules of the set of modules 220, 720 may be adjusted by applying the one or more optimal solutions of the one or more weights and one or more values of the one or more constraints on the estimated posterior distribution.

In block 540, the optimized parameters of the modules of the set of modules 220, 720 may be updated based on the adjusted estimated posterior distribution over the combinations of one or more modules of the set of modules 220, 720, in order to fit the updated structure distribution.

In an example, suppose θ is fixed, the objective of the probabilistic generation model may be given by maximizing the evidence of the observed data samples, which may be written as:

$${min}_{φ} {ℓ}_{prob} ( φ , θ ) := {\sum }_{n} - log p ( {x}_{n} , {y}_{n} ) \qquad ( 4 )$$

$$= {\sum }_{n} - [ log p ( {x}_{n} ) + log p ( {y}_{n} \vert {x}_{n} ) ]$$

$$\approx {\sum }_{n} - {E}_{G \sim {q}_{φ}} [ log {p}_{φ} ( {x}_{n} \vert G ) - β log {q}_{φ} ( G \vert {x}_{n} ) + β log p ( G ) + γ log {p}_{n e t} ( {y}_{n} \vert {x}_{n} , G , θ ) ] ,$$

Where γ is the scaling hyper-parameter of the prediction likelihood, and β is a constant parameter that satisfies β>1. Since [symbol] _{prob}(φ,θ) may not be differentiable for the expectation E_{G˜q}_{_{φ}}, the REINFORCE algorithm may be applied to get an estimated gradient for the updates to q_{φ}. Updates to p_{φ} may be computed directly with gradients.

Suppose the PGM 210, 710 parameters φ have achieved optimum, optimizing process over θ may become optimizing the network execution performance, which may be written as:

min_{θ} [symbol] ₑᵣᵣ(φ,θ)=Σ_{D}Σ_{G˜q}_{_{φ}}[−log pₙₑₜ(yₙ|xₙ,G,θ)] (5)

Where the gradient ∇_{θ} [symbol] ₑᵣᵣ(φ,θ) may be estimated with stochastic gradient descent (SGD) with structure G sampled during training.

Suppose the results of above optimization procedure regarding formulation (2) are denoted with φ₀ and θ₀, and the estimated posterior distribution of structures may be denoted by \tilde{p}_{φ}_{₀}(G|x). In order to give an approximated solution to formulation (3), φ₀ may be regarded as fixed, and the objective may be transformed into a RegBayes formation, which may be written as:

$${min}_{φ , ξ , η} KL [ {q}_{φ} ( G \vert x ) ‖ {\tilde{p}}_{{φ}_{0}} ( G \vert x ) ] + C {\sum }_{i = 1}^{L} {ξ}_{i} , \qquad ( 6 )$$

$$s . t . {E}_{{x}_{n} ∈ D} \vert {E}_{G \sim {q}_{φ}} [ {\sum }_{j = 1}^{{T}_{i}} {Φ}_{i j} ( G , {x}_{n} ) ] \vert \leq {ξ}_{i} + ϵ ,$$

In an aspect of the present disclosure, a dual problem introduced by convex analysis may be applied to find solution to formulation (6). Therefore, by introducing variables of dual problem, μ, optimal distribution of the RegBayes objective may be obtained by following formulation:

$${q}_{φ} ( G \vert x ; {μ}^{*} ) = \frac{{\tilde{p}}_{{φ}_{0}} ( G \vert x )}{Z ( {μ}^{*} )} exp ( {\sum }_{i = 1}^{L} {μ}^{*} {Φ}_{[ i ]}^{( D )} ( G , x ) ) \qquad ( 7 )$$

Where Φ_{[i]}^{(D)}(G,x) is the grouped summation of FOL constraints in the i-th group,

Φ_{[i]}^{(D)}(G,x):=Σⱼ₌₁^{T}^{ᵢ}Φᵢⱼ^{(D)}(G,x) (8)

Where each Φᵢⱼ^{(D)}(G,x) is an expectation value over observed samples for the corresponding constraint function,

Φᵢⱼ^{(D)}(G,x):=Eₓ_{ₙ}_{ϵD}[Φᵢⱼ(G,xₙ)] (9)

Z(μ*) is the normalization factor for q_{φ}, where μ* is the optimal solution of the dual problem:

$${max}_{μ} L ( μ ) = - log Z ( μ ) - ϵ {\sum }_{i = 1}^{L} {μ}_{i} , \qquad ( 10 )$$

$$s . t . \vert {μ}_{i} \vert \leq C , ∀ i = 1 , 2 , … . , L$$

where C and ϵ are hyper-parameter in formulation (3).

The optimization of dual problem (10) may be processed with an approximated stochastic gradient descent (SGD) procedure. Specifically, the gradient may be approximated as:

∂_{μ}_{ᵢ}log Z(μ)=Σ_{G}q_{φ}(G|x)Φ_{[i]}^{(D)}(G,x)≈\hat{Φ}_{[i]}(G,x), ∀i=1,2, . . . L (11)

Where the first equation is due to duality, and the approximation is to estimate the expectation with \hat{Φ}_{[i]}(G,x), which may be given by uniformly sampling over the observed samples and calculating the constraint function values. Specifically, the updates to μᵢ may be given by the SGD rule:

μᵢ^{(t+1)}=Proj_{[-C,C]}(μᵢ^{(t)}+rₜ(−∂_{μ}_{ᵢ}logZ(μ)+ϵ)) (12)

Where Proj_{[-C,C]} denotes the Euclidean projection of the input to [31 C,C], and rₜ is the step length. After solving for μ* , the regularized posterior distribution of structures q_{φ}(G|x) may be given by the formulation (7). The module parameters θ may be further optimized to fit the updated structure distribution.

In an example, the overall pipeline of the exemplary optimization process 500 may be presented in Algorithm 1.

Algorithm 1:

```
♦ Randomly initialize θ, φ and μ
♦ While converged do
        1) Set θ fixed, calculate the gradient ∇φ [symbol]  _{prob}(φ, θ) to
        update φ according to formulation (4) ;
        2) Set q_{φ} fixed, calculate the gradient ∇_{θ} [symbol] ₑᵣᵣ (φ, θ) to
        update θ according to formulation (5) ;
♦ end
♦ let φ₀ denote the result of the above procedure;
♦ While converged do
        3) Update μ according to the dual problem (10), where
        the updates are given in the formulation (12) ;
♦ end
♦ 4) calculate q_{φ} (G|x) in formulation (7) with φ₀ and μ* ;
♦ While converged do
        5) Calculate the gradient ∇_{θ} [symbol] ₑᵣᵣ (φ, θ) to update θ
        according to formulation (5) ;
♦ end
```

Where μ may be considered as weights of the FOL constraints. In an aspect of the present disclosure, one or more FOL constraints may be grouped into one or more groups of FOL constraints, and the grouped FOL constraints may collectively correspond to only one weight. As illustrated in step 3) of Algorithm 1, the optimization process 500 may have to perform multiple iteration computations to update each of weights until converged. The grouped FOL constraints may reduce the number of weights, which may save computation resources accordingly.

In another aspect of the present disclosure, a value of a FOL constrain may be determined based on a correlation between a set of inputs and a module in a combination of one or more modules of the set of modules generated according to the estimated posterior distribution given the set of inputs. For instance, the correlation may relate to whether the semantic representation of a module in a structure that is generated according to the estimated posterior distribution (e.g., given xₙ,φ₀) can be found in S(xₙ), as illustrated by formulation (1).

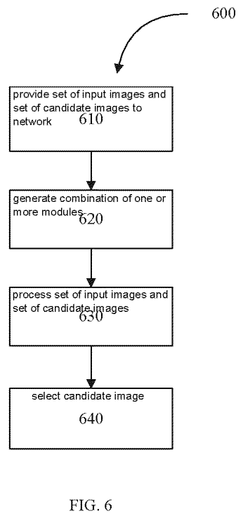

FIG. 6 shows an exemplary flow chart illustrating a method 600 for performing an abstract visual reasoning task with a probabilistic neural-symbolic model that is regularized with domain knowledge, according to one or more aspects of the present disclosure. For instance, the method 600 may be performed by the network 200 or network 700 that will be described in details hereafter. For another instance, the method 600 may be performed by other networks, systems or models.

In block 610, the network 200, 700 may be provided with a set of input images and a set of candidate images.

In block 620, a combination of one or more modules of the set of modules 220, 720 may be generated based on a posterior distribution over combinations of one or more modules of the set of modules 220, 720 and the set of input images, wherein the posterior distribution is formulated by the PGM 210, 710 trained under domain knowledge as one or more posterior regularization constraints. In an example, the training process may be performed according to the method 400 by reference to FIG. 4 illustrated above.

In block 630, the set of input images and the set of candidate images may be processed through the generated combination of one or more modules of the set of modules 220, 720.

In block 640, a candidate image may be selected from the set of candidate images based on a score of each candidate image in the set of candidate images estimated by the processing.

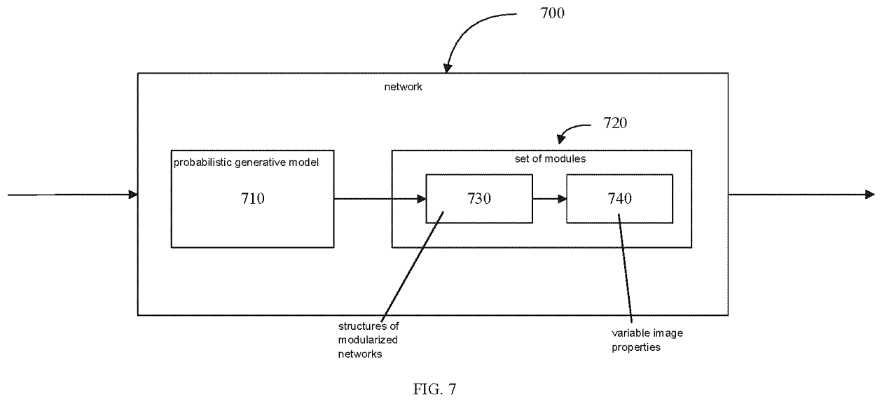

FIG. 7 illustrates another example network 700 in which aspects of the present disclosure may be performed. Network 700 may be an example of network 200 as illustrated by FIG. 2. For instance, the network 700 may include a probabilistic generative model (PGM) 710 and a set of modules 720, such as an inventory of reusable modules. The PGM 710 and the set of modules 720 may be an example of PGM 210 and set of modules 220, respectively. Each module of the set of modules 720 may comprise one of types of processing that may be pre-designed to evaluate whether the panels satisfy a specific relation. The types of processing may comprise logical AND, logical OR, logical XOR, arithmetical ADD, arithmetical SUB, arithmetical MUL, and the like. Additionally, each module of the set of modules 720 may comprise one or more trainable parameters for focusing that module on one or more variable image properties. For instance, a module may have a type of logical AND, and may focus on different image properties via the trainable parameters trained by a dataset. For instance, the module with the type of logical AND may perform a logical AND between line colours, and may also perform a logical AND between shape positions, depending on different trained values of the trainable parameters.

In an aspect of the present disclosure, each module of the set of modules 720 may be configured to perform a pre-designed process on one or more variable image properties, and the one or more variable image properties may be resulted from processing an input image feature map through at least one trainable parameters. For instance, a module with a type of logical AND may be represented as follow:

ƒ_{AND}(d, e)=(W_{d}·d)Λ(Wₑ·e) (13)

Where d and e are input panel features, W_{d} and Wₑ are trainable parameters for focusing on a specific panel property.

In an aspect of the present disclosure, an image panel property may comprise of any property that may be exhibited on an image. In another aspect of the present disclosure, with the guidance of domain knowledge, one or more variable image properties may comprise shape, line, size, type, color, position, or number or the like that are based at least in part on triples [symbol] {[r,o,a]} from which constraints may be depend.

In an aspect of the present disclosure, PGM 710 may be configured to output a posterior distribution over structures of modularized networks 730 assembled from the set of modules 720, where the structures 730 may identify the types of the assembled modules and connections therebetween. The one or more variable image properties of each module 740 may be determined by training the at least one trainable parameters. The separate generation of structures 730 (e.g., generated by the PGM 710) and variable image properties 740 (e.g., generated based on the trainable parameters) may provide the network 700 with more flexibility on high-level concept abstracting and representative learning.

FIG. 8 shows an exemplary diagram illustrating an example of performing method 400, optimization process 500 or method 600 by network 800, according to one or more aspects of the present disclosure. For instance, the network 800 may be an example of network 200 or network 700. For instance, a VAE comprising an encoder 810-1 and a decoder 810-2 may be an example of the PGM 210 or 710. The set of modules 820 may be an example of set of modules 220, 720, and may form structures G=(v,A). Sub-network 860 may be used to compute a score of each candidate image panel that may indicate a degree of correlation between each candidate image panel and a result of processing a set of input panels according to a generated modularized network with a structure G=(v,A). For instance, the score may be computed based on various metrics, such as an energy function, where higher energy may indicate better correlation. Posterior distribution unit 850 may store parameters of a posterior distribution outputted by the encoder 810-1, and based on which a structure may be generated, for example, by sampling according to the parameters of the posterior distribution.

In an example, the method 400 may start with providing the network 800 with sets of inputs and sets of outputs (e.g., via route 1), wherein each set of inputs (e.g., X₁ of 3×3 panels of FIG. 8) of the sets of inputs mapping to one of a set of outputs (e.g., the first panel in first row of Y₁ of FIG. 8) corresponding to the set of inputs based on visual information on the set of inputs, and wherein the network 800 comprising a Probabilistic Generative Model (PGM) (e.g., an encoder 810-1 and a decoder 810-2) and a set of modules 820. The encoder 810-1 may map or encode the set of inputs X₁ into distribution parameters (e.g., λ₁,σ₁ when assume p(G|x)˜N(λ,σ)) for one or more variables (e.g., total 20 variables for a summation of 4×4 adjacency matrix entries and 4 vertexes of the examples of FIG. 3A and FIG. 3B), based on which a structure G=(v,A) may be generated. The sets of inputs X₁ and/or outputs Y₁ may be provided to and processed by the generated modularized network with the generated structure G=(v,A) via route 2. The sub-network 860 may use the processed inputs X₁ and outputs Y₁ to compute the score of the correct output (e.g., the first panel in first row of Y₁ of FIG. 8), via routes 3 and 5.

The method 400 may repeat the procedure described reference to the inputs X₁ and outputs Y₁, e.g., with X₂, Y₂, X₃, Y₃, . . . , Xₙ, Yₙ. The parameters φ,θ of encoder 810-1, decoder 810-2 and modules of set of modules 820 may be updated according to the optimization process 500 described above reference to FIG. 5, to obtain the estimated posterior distribution of structures, which may be denoted by \tilde{p}_{φ}_{₀}(G|x). Additionally, optimal solutions of weights μ* may be obtained and used to compute the regularized posterior distribution of structures, according to the optimization process 500 described above reference to FIG. 5, e.g., via route 6. Preferably, the parameters θ of the modules of set of modules 820 may be further updated to fit the updated regularized posterior distribution of structures.

In an aspect of the present disclosure, the decoder 810-2 may be used for a backward propagation, e.g., via route 4. In another aspect of the present disclosure, the decoder 810-2 may be omitted.

In an example, the method 600 may be performed for an inference process after the network 800 have been trained according to the method 400 and/or optimization process 500.

It will be appreciated by those skilled that the posterior distribution unit 850 and/or the sub-network 860 may be incorporated into one or more parts of the network 800, rather than being illustrated as a separate part in FIG. 8, depending on a design preference and/or a specific implementation, without departure of the present disclosure.

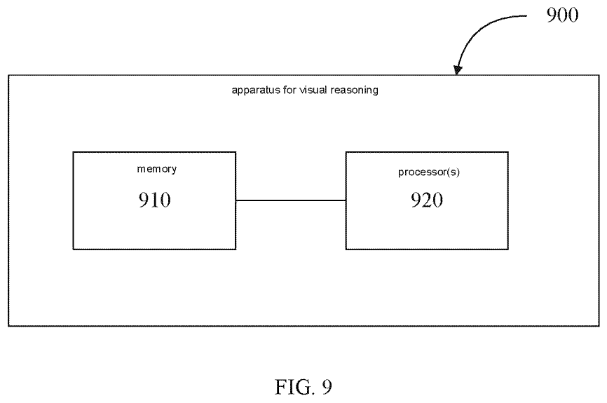

FIG. 9 illustrates an example of a hardware implementation for an apparatus 900 according to an embodiment of the present disclosure. The apparatus 900 for visual reasoning may comprise a memory 910 and at least one processor 920. The processor 920 may be coupled to the memory 910 and configured to perform the method 400, optimization process 500, and method 600 described above with reference to FIGS. 4, 5 and 6. The processor 920 may be a general-purpose processor, or may also be implemented as a combination of computing devices, e.g., a combination of a DSP and a microprocessor, multiple microprocessors, one or more microprocessors in conjunction with a DSP core, or any other such configuration. The memory 910 may store the input data, output data, data generated by processor 920, and/or instructions executed by processor 920.

The various operations, models, and networks described in connection with the disclosure herein may be implemented in hardware, software executed by a processor, firmware, or any combination thereof. According an embodiment of the disclosure, a computer program product for visual reasoning may comprise processor executable computer code for performing the method 400, optimization process 500, and method 600 described above with reference to FIGS. 4, 5 and 6. According to another embodiment of the disclosure, a computer readable medium may store computer code for visual reasoning, the computer code when executed by a processor may cause the processor to perform the method 400, optimization process 500, and method 600 described above with reference to FIGS. 4, 5 and 6. Computer-readable media includes both non-transitory computer storage media and communication media including any medium that facilitates transfer of a computer program from one place to another. Any connection may be properly termed as a computer-readable medium. Other embodiments and implementations are within the scope of the disclosure.

The preceding description of the disclosed embodiments is provided to enable any person skilled in the art to make or use the various embodiments. Various modifications to these embodiments will be readily apparent to those skilled in the art, and the generic principles defined herein may be applied to other embodiments without departing from the scope of the various embodiments. Thus, the present invention is not intended to be limited to the embodiments shown herein but is to be accorded the widest scope consistent with the principles and novel features disclosed herein.

1-18. (Canceled).

19. A method for visual reasoning, comprising the following steps:
providing a network with sets of inputs and sets of outputs, wherein each set of inputs of the sets of inputs mapping to one of the sets of outputs corresponding to the set of inputs based on visual information on the set of inputs, and wherein the network includes a Probabilistic Generative Model (PGM) and a set of modules;
determining a posterior distribution over combinations of one or more modules of the set of modules through the PGM, based on the provided sets of inputs and sets of outputs; and
applying domain knowledge as one or more posterior regularization constraints on the determined posterior distribution.

20. The method of claim 19, wherein the one or more posterior regularization constraints are grouped into one or more groups of constraints according to one or more aspects of the domain knowledge.

21. The method of claim 20, wherein the one or more aspects of the domain knowledge include one or more of: logical reasoning, and/or temporal reasoning, and/or spatial reasoning, and/or arithmetical reasoning.

22. The method of claim 19, wherein the one or more posterior regularization constraints are one or more First-Order Logic (FOL) constraints.

23. The method of claim 22, wherein the one or more FOL constraints are generated based on at least one of: relation types of the sets of inputs, and/or object types of the sets of inputs, and/or attribute types of the sets of inputs.

24. The method of claim 19, wherein each of the combinations of one or more modules of the set of modules includes a modularized network, the modularized network is assembled from one or more modules of the set of modules with a structure indicating the assembled one or more modules and connections therebetween.

25. The method of claim 24, further comprising:
determining a posterior distribution over structures of modularized networks through the PGM, based on the provided sets of inputs and sets of outputs.

26. The method of claim 24, wherein each module of the set of modules includes at least one trainable parameters for focusing the module on one or more variable image properties, and is configured to perform a pre-designed type of process on the one or more variable image properties, and the method further comprising:
determining, through the PGM, a posterior distribution over structures of modularized networks indicating types of the assembled one or more modules and connections therebetween, based on the provided sets of inputs and sets of outputs.

27. The method of claim 19, wherein the method further comprises optimizing the network by:
updating parameters of the PGM and parameters of modules of the set of modules alternatively by maximizing evidences of the sets of inputs and the sets of outputs, to obtain an estimated posterior distribution over the combinations of one or more modules of the set of modules and optimized parameters of the modules of the set of modules;
updating one or more weights of the one or more posterior regularization constraints applied to the estimated posterior distribution over the combinations of one or more modules of the set of modules, to obtain one or more optimal solutions of the one or more weights;
adjusting the estimated posterior distribution over the combinations of one or more modules of the set of modules, by applying the one or more optimal solutions of the one or more weights and one or more values of the one or more constraints on the estimated posterior distribution; and
updating the optimized parameters of the modules based on the adjusted estimated posterior distribution over the combinations of one or more modules of the set of modules.

28. The method of claim 27, wherein the one or more posterior regularization constraints are grouped into one or more groups of constraints, and each group of constraints corresponding to one weight.

29. The method of claim 27, wherein a value of each constraint is determined based on a correlation between a set of inputs and a module in a combination of one or more modules of the set of modules generated according to the estimated posterior distribution given the set of inputs.

30. A method for visual reasoning with a network, wherein the network includes a Probabilistic Generative Model (PGM) and a set of modules, the method comprising the following steps:
providing the network with a set of input images and a set of candidate images;
generating a combination of one or more modules of the set of modules based on a posterior distribution over combinations of one or more modules of the set of modules and the set of input images, wherein the posterior distribution is formulated by the PGM trained under domain knowledge as one or more posterior regularization constraints;
processing the set of input images and the set of candidate images through the generated combination of one or more modules; and
selecting a candidate image from the set of candidate images based on a score of each candidate image in the set of candidate images estimated by the processing.

31. An apparatus for visual reasoning, comprising:
a memory; and
at least one processor coupled to the memory and configured for visual reasoning, the at least one processor configured to:
provide a network with sets of inputs and sets of outputs, wherein each set of inputs of the sets of inputs mapping to one of the sets of outputs corresponding to the set of inputs based on visual information on the set of inputs, and wherein the network includes a Probabilistic Generative Model (PGM) and a set of modules,
determine a posterior distribution over combinations of one or more modules of the set of modules through the PGM, based on the provided sets of inputs and sets of outputs, and
apply domain knowledge as one or more posterior regularization constraints on the determined posterior distribution.

32. A non-transitory computer readable medium on which is stored computer code for visual reasoning, the computer code when executed by a processor, causing the processor to perform the following steps:
providing a network with sets of inputs and sets of outputs, wherein each set of inputs of the sets of inputs mapping to one of the sets of outputs corresponding to the set of inputs based on visual information on the set of inputs, and wherein the network includes a Probabilistic Generative Model (PGM) and a set of modules;
determining a posterior distribution over combinations of one or more modules of the set of modules through the PGM, based on the provided sets of inputs and sets of outputs; and
applying domain knowledge as one or more posterior regularization constraints on the determined posterior distribution.

33. A network for visual reasoning, comprising:
a set of modules, wherein each module of the set of modules being implemented as a neural network and having at least one trainable parameters for focusing the module on one or more variable image properties; and
a Probabilistic Generative Model (PGM) coupled to the set of modules, wherein the PGM is configured to output a posterior distribution over combinations of one or more modules of the set of modules.

34. The network of claim 33, wherein each of the set of modules is configured to perform a pre-designed type of process on the one or more variable image properties, and the one or more variable image properties are resulted from processing an image feature map through the at least one trainable parameters.

35. The network of claim 34, wherein the one or more variable image properties includes one or more of: shape, and/or line, and/or size, and/or type, and/or color, and/or position, and/or number, and the pre-designed type of process includes logical AND, or logical OR, or logical XOR, or arithmetic ADD, or arithmetic SUB, or arithmetic MUL, or spatial STRUC, or temporal PROG, or temporal ID.
